(19) United States
(12) Patent Application Publication
(10) Pub. No.: US 2017/0121226 A1
(43) Pub. Date: May 4, 2017

(54) MULTI-FUNCTIONAL OPEN GRADED FRICTION COURSE FOR IN SITU TREATMENT OF HIGHWAY OR ROADWAY RUNOFF

(71) Applicant: University of Louisiana at Lafayette, Lafayette, LA (US)

(72) Inventors: Daniel Dianchen Gang, Lafayette, LA (US); Mohammad Jamal Khattak, Lafayette, LA (US)

(21) Appl. No.: 15/337,211

(22) Filed: Oct. 28, 2016

Related U.S. Application Data
(60) Provisional application No. 62/248,335, filed on Oct. 30, 2015.

(51) Int. Cl. C04B 26/26; B01J 20/12; C02F 1/28; B01J 20/10; E01C 11/24; C04B 14/28; B01J 20/18

(52) U.S. Cl. CPC C04B 26/26; C04B 14/28; B01J 20/12; B01J 20/18; B01J 20/103; E01C 11/24; C02F 1/283; C02F 1/281; C04B 2103/0078

(57) ABSTRACT

A multi-functional open graded friction course and a method of treating highway water runoff using the multi-functional open graded friction course are described herein. Open graded friction course is treated with an additive or additives, such as, but not limited to, an adsorbent. After treatment with the additive, the additive remains in the void spaces in the open graded friction course, thus creating a multi-functional open graded friction course. When highway or roadway water runoff flows into the void spaces, pollutants, such as heavy metals, are adsorbed by the additives and the water then flows laterally out of the multi-functional open graded friction course.

### CROSS REFERENCE TO RELATED APPLICATIONS

This application claims priority to the Provisional U.S. patent application No. 62/248,335 entitled “Multi-functional Open Graded Friction Course for In Situ Treatment of Highway or Roadway Runoff,” filed Oct. 30, 2015.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### BACKGROUND OF THE INVENTION

Described herein is a multi-functional open graded friction course (MOGFC) for in situ treatment of highway or roadway runoff and methods of using the same. Highways or roadways have been recognized as a common source of various pollutants, including, but not limited to, heavy metals, suspended solids, and organic compounds. Examples of sources of pollution include, but are not limited to, the abrasion of asphalt and tires, corrosion of crash barriers, deposition of exhaust products, and leakage from vehicles. Highway or roadway runoff conveys a large portion of these contaminants to adjacent water bodies, resulting in an accumulation of pollutants, especially under high traffic volumes. Studies have shown that highway runoff can have chronic toxicity resulting from bioaccumulation of pollutants, though it may not demonstrate acute toxicity.

Highway or roadway runoff is a non-point pollution source and it is a significant contributor to water quality degradation when combined with other sources, such as, but not limited to, urban runoff Non-point sources of urban runoff have serious detrimental effects on water quality and an estimated 50% to 70% of heavy metal pollutants from non-point sources are attributed to roadways.

Copper (Cu) and zinc (Zn) are the two predominant heavy metals that are found in highway or roadway runoff. Copper in highway or roadway runoff is likely from brake lining wear, metal plating, moving engine parts, and bearing and bushing wear. Zinc in highway or roadway runoff is likely from tire wear, motor oil, and grease. FIG. 1 is a table that lists typical metals found in highway runoff.

Heavy metals can impact the receiving catchment, groundwater quality, and surrounding ecosystem. Therefore, significant environmental benefits may be realized by reducing heavy metals in highway or roadway runoff.

Traditional highway runoff collection and treatment systems include a variety of structural practices such as sand filters, retention and detention structures, and nonstructural practices including but not limited to vegetated buffer strips and grassy swales. These methods often require high investment costs and frequent maintenance. Some methods also require substantial land area for the treatment setup, and are not able to function properly if located near a bridge or deck with long spans.

Open graded friction course (“OGFC” or “OGFC overlay”), also known as permeable friction course (“PFC”) is a porous asphalt concrete layer, approximately 50 mm thick that is laid on top of a conventional concrete or asphalt surface to provide an alternative to the aforementioned traditional methods for treating highway runoff. OGFC is produced by eliminating the fine aggregate from conventional hot mix asphalt (“HMA”). Generally, an OGFC overlay consists of approximately 18% to approximately 22% air voids. Highway or roadway runoff soaks into the OGFC layer and is held in the pore spaces until it is drained laterally through subsurface drains or percolates through the base or layers under the OGFC.

OGFC provides a benefit to transportation agencies by collecting water in the voids in the OGFC (which are also referred to herein as “pores”) and eliminating surface water flows. This results in reductions in splash, spray, and hydroplaning on road surfaces; improvements in visibility and traction on road surfaces; and reductions in highway noise. In addition, the OGFC surface decreases sunlight reflections and headlight glare from the pavement, which enables road signs and markings to be more visible to the drivers. Thus the cumulative advantages of OGFC should improve the safety of the roadway.

Furthermore, the installation of OGFC overlay can produce noticeable improvements in the quality of highway runoff water. It has been demonstrated that runoff treated by OGFC overlay is less polluted due to particulate retention in the pore spaces. OGFC overlay has also been proven to improve runoff water quality, over that of non-OGFC road surfaces.

However, traditional OGFC has little to no ability to remove dissolved/non particulate (as opposed to particulate) related pollutants, including but not limited to, heavy metals, from highway or roadway runoff. The pore size in the traditional OGFC layer is too large to retain colloidal and dissolved constituents, especially heavy metal ions, including but not limited to, Cu²⁺, Zn²⁺, Cd, Ni, Fe, Pb, and Cr. Therefore an alternative to traditional OGFC is required to address the need to remove non-particulate matter from roadway runoff.

### DESCRIPTION OF THE DRAWINGS

The drawings constitute a part of this specification and include exemplary embodiments of the Multi-functional Open Graded Friction Course for In Situ Treatment of Highway or Roadway Runoff, which may be embodied in various forms. It is to be understood that in some instances, various aspects of the invention may be shown exaggerated or enlarged to facilitate an understanding of the invention. Therefore the drawings may not be to scale.

FIG. 1 is a Table that lists typical metals found in highway runoff. Heavy metals can impact the receiving catchment, groundwater quality, and surrounding ecosystem.

FIG. 2 illustrates the removal of pollutants, such as heavy metals. A typical cross section of a traditional OGFC sample is presented in the upper part of the figure, which depicts interconnected and not connected air voids. The interconnected air voids can drain water laterally from the sides. In the bottom part of the figure, a typical cross section of the MOGFC, as described herein, is shown for comparison.

FIG. 3 depicts the various embodiments of OGFC that were prepared in the Examples. The samples were prepared using different air voids with the same aggregate composition. The air voids were varied by keeping the sample thickness constant and changing the mass and compaction level (the number of gyrations) using a Superpave Gyratory Compactor.

FIG. 4 is a table that lists the aggregate gradation used.

FIG. 5 is an asphalt permeameter (approximately 150 millimeter), manufactured by Global Gilson used in the Examples to perform permeability and removal experiments.

FIG. 6 is the total air voids and interconnected air voids for OGFC. A normal trend of the plot showed that interconnected air voids increase as the total air void increased. The range of interconnected air voids was smaller than total air voids, which was expected because interconnected air voids are a portion of total air voids and do not include the air voids that are not accessible by water.

FIG. 7 is the permeability of each OGFC plotted as a function of total air voids and interconnected air voids. The data in the figure shows that permeability increases as the interconnected and total air voids increase.

FIG. 8 is the total air voids and interconnected air voids for MOGFC. Interconnected air voids increase as total air voids increase. The range of interconnected air voids was smaller than total air voids.

FIG. 9 is the permeability of multiple embodiments of MOGFC plotted as a function of total air voids and interconnected air voids. The average rate of permeability of MOGFC was calculated as approximately 214 meters/day, which was smaller than the rate of permeability of OGFC (approximately 248 meters/day).

FIG. 10 lists the operational parameters of the Atomic Absorption Spectrometer (AAS).

FIG. 11 shows data for the adsorption of Cu by bentonite fitted to both Langmuir and Freundlich adsorption isotherm models. The figure demonstrates good adsorption of Cu by bentonite. The figure also shows sorpotion data on silica and suggest that silica has a lower adsorption capacity for Cu, compared to that of bentonite.

FIG. 12 is a table that shows the isotherm parameters of Cu adsorption by silica, bentonite, zeolite, and fly ash.

FIG. 13 is the zeolite adsorption capacity for Cu as determined using Langmuir and Freundich adsorption isotherm models. It indicates that zeolite has a higher adsorption capacity for Cu than that of bentonite and silica. It also shows the adsorption of Cu by fly ash and indicates that fly ash was more favored by bentonite, silica, and zeolite. Similarly, fly ash demonstrated a higher adsorption capacity for Cu than that of zeolite, bentonite, and silica

FIG. 14 is the bentonite adsorption capacity for Zn as determined using Langmuir and Freundich adsorption isotherm models. It indicates that Zn adsorption onto bentonite is favored. It also shows data of Zn adsorption onto organo clay and demonstrates that organo clay has a lower adsorption capacity for Zn than that of bentonite.

FIG. 15 is a table that shows the relative constant values with regression coefficients calculated from the two models, Langmuir and Freundlich, for Zn adsorption by organo clay, bentonite, zeolite, and fly ash.

FIG. 16 is the fly ash adsorption capacity for Zn as determined using Langmuir and Freundich adsorption isotherm models. It indicates a higher affinity of Zn to the binding sites of fly ash than that of Zn to other adsorbents.

FIG. 17 is a table that compares Cu and Zn adsorption capacities for each of the adsorbents. Silica and organo clay both have very low adsorption capacities for Cu and Zn. Bentonite, zeolite, and fly ash provided moderate to high adsorption capacities for both Cu and Zn.

FIG. 18 is the Cu removal efficiencies of varying embodiments of MOGFC with different bentonite dosages. Conventional OGFC, without any bentonite dosage, did not show any significant removal of Cu. However after introducing bentonite, Cu removal efficiencies were significantly improved.

FIG. 19 is the Zn removal efficiencies of varying embodiments of MOGFC with different bentonite dosages. Conventional OGFC, without any bentonite dosage, did not show any significant removal of Zn. However after introducing bentonite, Zn removal efficiencies were significantly improved.

FIG. 20 is the Cu removal efficiency of and embodiment of MOGFC with zeolite added. The percentage of the total mass of zeolite was lower than that of bentonite. The larger particle size of zeolite prevented a higher concentration in the voids

FIG. 21 is the Zn removal efficiency of varying embodiments of MOGFC with zeolite added. The maximum removal efficiency of zeolite for Cu is greater than the maximum removal efficiency of zeolite for Zn. An embodiment of MOGFC with zeolite could adsorb more Cu than Zn.

FIG. 22 is the Cu removal efficiency of an embodiment of MOGFC with fly ash added. Conventional OGFC, without any fly ash dosage, did not show any significant removal for Cu. After introducing fly ash, Cu removal efficiencies were significantly improved.

FIG. 23 is the Zn removal efficiency of an embodiment of MOGFC with fly ash added. Conventional OGFC, without any fly ash dosage, did not show any significant removal for Zn. After introducing fly ash, Zn removal efficiencies were significantly improved.

FIG. 24 is a table that lists the metal removal efficiency parameters for various embodiments of MOGFC comparing each metal, Cu and Zn, with each adsorbent, fly ash, bentonite, and zeolite. Each adsorbent has a higher removal efficiency with Cu compared to the removal efficiency for Zn. Fly ash had the best removal efficiency for both Cu and Zn.

FIG. 25 demonstrates the Indirect Tensile Stress of OGFC and one embodiment MOGFC. No significant change of Tensile Strength Ratio values were observed in MOGFC and OGFC during the moisture conditioning. This result confirmed that MOGFC is resistant to the moisture induced damage.

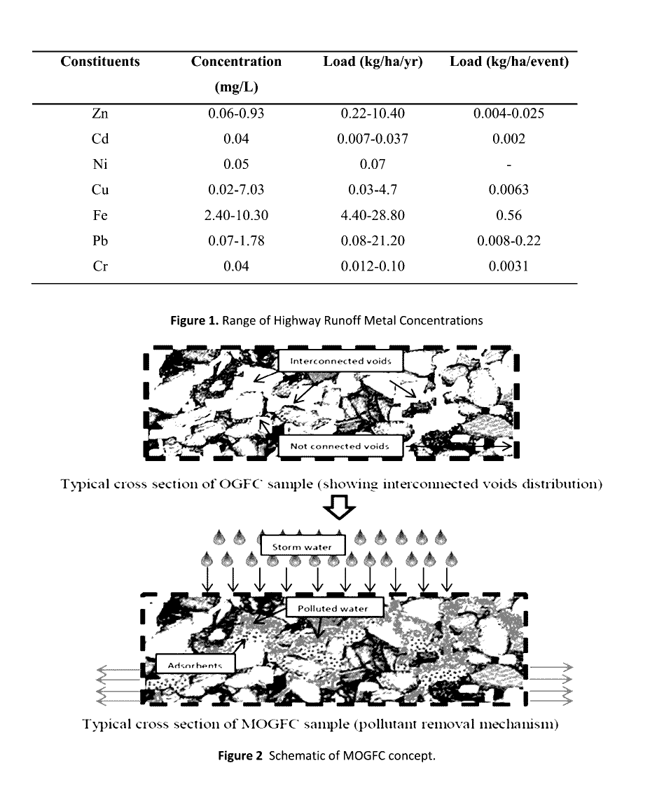

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. In the following description, numerous specific details are provided, such as examples of absorbents, additives, and pollutants. One skilled in the relevant art will recognize, however, that multi-functional open graded friction course may be practiced without one or more of the specific details, or with other methods, components, materials, and so forth. In other instances, well-known structures, materials, or operations are not shown or described in detail to avoid obscuring aspects of the invention.

Described herein, is a novel in situ storm water management technique, which creates a new type of material, multi-functional open graded friction course (MOGFC), by adding additives into the voids of Open graded friction course (OGFC) mixtures. The resulting new material, called MOGFC, has adsorption capabilities for heavy metals and other pollutants, and thus forms an in situ treatment for highway or roadway runoff.

The additives in MOGFC are located in the pore spaces (also referred to herein as “voids”) and adsorb heavy metals and other pollutants when water travels into the voids vertically and drains out laterally. FIG. 2 illustrates the concept of the mechanism for removal of pollutants, such as, but not limited to, heavy metals. A typical cross section of a traditional OGFC sample is presented in the upper part of FIG. 2. OGFC contains interconnected air voids only. Through the interconnected air voids water can drain out laterally from the sides. FIG. 2 depicts an embodiment of the MOGFC. In the MOGFC, adsorbents, in particulate form, can be seen at the edge of interconnected air voids. Water contaminated with pollutants, percolates vertically into the MOGFC and travels through interconnected air voids where the adsorbents are located. The adsorbents adsorb heavy metals and other pollutants and then the treated water percolates further and drains out laterally through the horizontal channel of interconnected air voids. The method of treating highway or roadway runoff water with MOGFC has both environmental and economic benefits, as it eliminates the need for external treatment facilities for highway runoff Thus, it has the potential to save on land usage and costs over traditional methods such as wetlands and detention ponds. Also, the method described herein is used in situ and therefore can be used on long span bridges, where it is not possible to use a pond, vegetative strip, or other external treatment methods.

In one embodiment, MOGFC comprises OGFC, prepared according to known practices, and an additive. In an alternate embodiment, the MOGFC comprises OGFC, prepared according to known practices, and at least one additive. In one embodiment, the additive comprises an adsorbent. Suitable adsorbents include bentonite, zeolite, fly ash/scrubber residue, organo clay, silica, or any compound or element that is capable of being maintained in the void space in the MOGFC and which adsorbs a pollutant that is present in highway or roadway runoff water, whether now known or discovered in the future. As used herein, the term “fly ash” includes scrubber residue. The terms highway and roadway, include any surface over which it is intended that a vehicle may be driven, including but not limited to surfaces that are concrete and asphalt.

In yet another embodiment, the adsorbent is selected from bentonite, zeolite, fly ash, organo clay, or silica. Alternatively, the adsorbent comprises any compound or element that is capable of being maintained in the void space in the MOGFC and which adsorbs a pollutant that is present in highway or roadway runoff water.

In another embodiment, a method of treating highway or roadway water runoff, said highway or roadway water runoff comprising at least one pollutant, comprises using MOGFC to remove at least some of at least one pollutant. In one embodiment, said pollutant comprises a heavy metal. In another embodiment, said heavy metal may comprise Zn, Cd, Ni, Cu, Fe, Pb, or Cr.

In another embodiment, a method of treating highway water runoff, in situ, comprises adding OGFC over a conventional roadway surface, then adding an additive to the OGFC, to produce MOGFC. The highway or roadway surface may comprise conventional concrete, conventional asphalt, or other surfaces over which vehicles traverse.

### Example 1

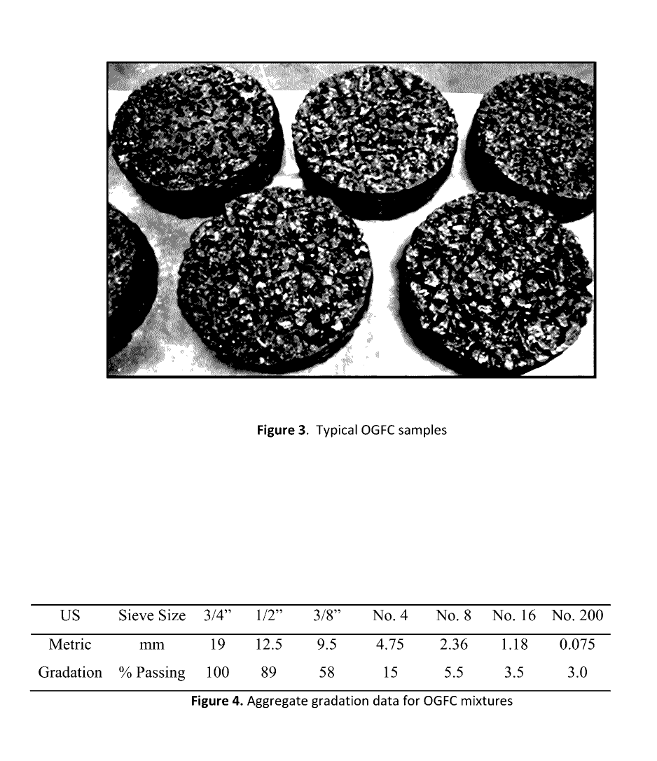

Various embodiments of OGFC were prepared with different air voids with the same aggregate composition, as shown in FIG. 3. The air voids were varied by keeping the sample thickness constant and changing the mass and compaction level (the number of gyrations) using a Superpave Gyratory Compactor. Limestone aggregates and viscosity graded polymer modified asphalt binder (PAC-40) were used to construct OGFC samples. Both materials were obtained from local contractors. The mix design yielded 5.5% asphalt content and 22% total air voids in the mixture at 50 gyrations. All samples used in the example were approximately 150 mm (approximately 5.9 inches) in diameter and approximately 76 mm (approximately 3 inches) thick. The aggregate gradation used in this example is shown in the table in FIG. 4.

Adsorbent dosage, as a percentage by mass of the OGFC sample, was determined. Then a portion of the total amount of adsorbent was evenly distributed on the surface of the sample. The OGFC sample was gently transferred to a mechanical sieve shaker. The sample was secured firmly and locked with the two sided clamp of the sieve shaker. The sample was shaken until adsorbent particles were entered into the interconnected air voids of OGFC. This procedure was repeated several times with the remaining amounts of adsorbents. Total shaking time for the sample was 30 minutes. This process resulted in the production of an embodiment of MOGFC.

Five different adsorbents were tested to determine their adsorption capacity for Cu and Zn removal for different embodiments of MOGFC. The adsorbents were: 1) Bentonite, 2) Zeolite, 3) Silica, 4) Organo clay, and 5) Fly ash. These adsorbents represent different embodiments of the invention.

Chemical solutions were prepared using de-ionized water and analytical grade chemicals. A copper standard solution (also referred to herein as “copper stock solution”) comprising approximately 1 mg/ml Cu in approximately 2% HNO₃ and a zinc standard solution (also referred to herein as “zinc stock solution”) comprising 1 mg/ml Zn in approximately 2% HCl, each for use with Atomic Absorption Spectrometer (AAS), were obtained. These two solutions are herein referred to as “stock solution.” Intermediate solutions and standard solutions were prepared before the experiment by diluting the stock solutions with deionized water. All glassware and plastic ware was washed with soap and water, followed by one tap water rinse, and then three final rinses with deionized water.

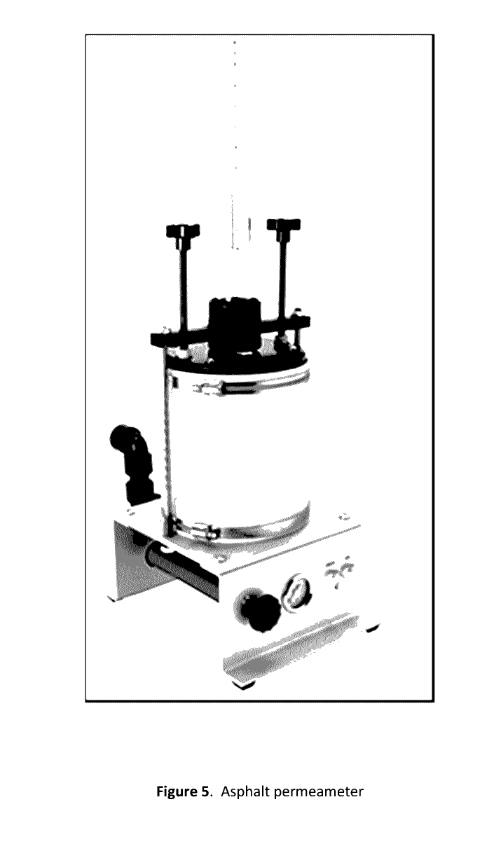

The permeability of various embodiments of OGFC and MOGFC specimens was determined according to the Florida Department of Transportation's Falling Head Laboratory Permeability Test Method. An asphalt permeameter (approximately 150 mm) (also referred to herein as “permeameter”), manufactured by Global Gilson and illustrated in FIG. 5, was used in this Example. Each specimen of OGFC and MOGFC was separately and securely wrapped with a thin rubber membrane to seal the outside of the specimen and only allow water to exit through the bottom surface when the specimen was fit snugly into the stand pipe of the permeameter. A thin layer of petroleum jelly was applied onto the plastic wrapped specimen for lubrication before the specimen was inserted into the stand pipe. A polymer-modified asphalt binder coating was then applied around the sides of each specimen to fill up all of the empty spaces, ensuring that no water would drain around the outer edges of the specimen. The permeameter is then pressurized by the built-in hand pump to approximately 100 kPa. Once the permeameter was secured, it was filled with water to a height of approximately 60 mm above the top of the specimen. The permeamter valve was opened and the time (t) required for the water to drop from the initial head, h₁=approximately 60 mm above the specimen to the final head, h₂=approximately 5 mm above the specimen was recorded and used to calculate the permeability using Eq. (1). The permeability (k) was measured three times on each specimen.

$$k = \frac{a L}{At} ln \frac{{h}_{1}}{{h}_{2}} \qquad ( 1 )$$

Where k=Permeability (meters/day), a=Cross-sectional area of the stand pipe (meters²), L=Thickness of the specimen (meters), A=Cross-sectional area of the specimen (meters²), t=Time, and h₁, h₂=water level in the stand pipe.

The bulk and maximum theoretical densities of various embodiments was determined in accordance with American Association of State highway and Transportation (AASHTO) T331 (Vacuum Sealing method) and AASHTO T209, respectively. These two tests were used to determine the total air void content (AVt) in each individual OGFC and MOGFC embodiment. Additionally, AASHTO T166 was conducted to determine the bulk specific gravity of the OGFC and MOGFC embodiments and to determine the air voids that are not connected (AVnc). The approximate value of interconnected air voids (AVc) was then calculated by subtracting the AVnc from AVt.

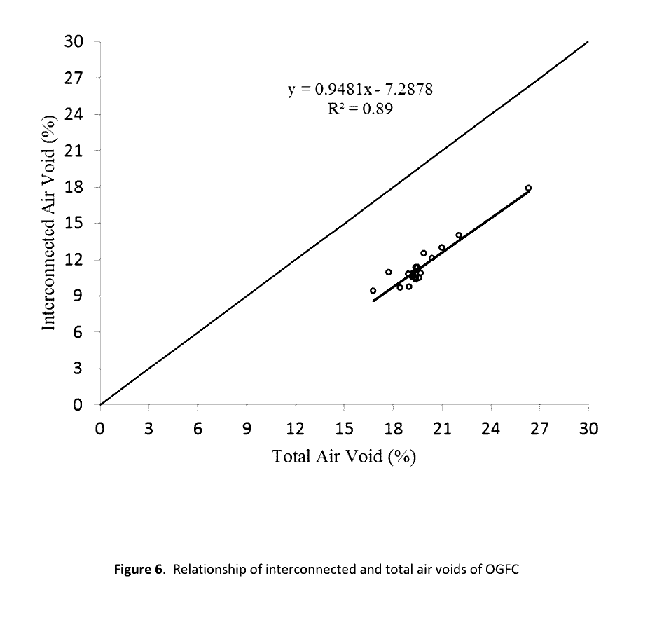

The total air voids and interconnected air voids are plotted in FIG. 6. A normal trend of the plot shows that interconnected air voids increase as total air void increases with a correlation coefficient of approximately 0.89. However the range of interconnected air voids was smaller than total air voids, which was expected because interconnected air voids are a portion of total air voids and do not include the air voids that are not accessible by water.

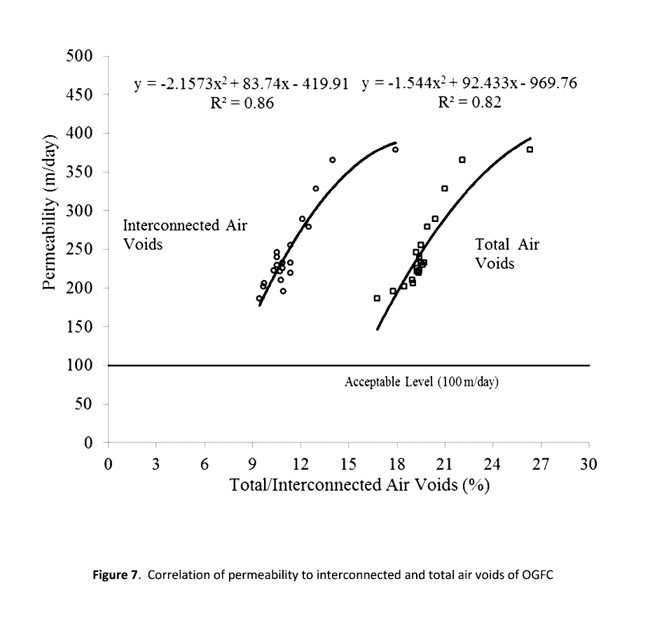

The permeability of each OGFC embodiment was measured and is plotted as a function of total air voids and interconnected air voids in FIG. 7. The data in FIG. 7 shows that permeability increases as the interconnected and total air voids increase. The corresponding correlation coefficients of permeability were approximately 0.86 and 0.82, respectively. The correlation coefficient with interconnected air voids was slightly higher than the total air voids, because interconnected air voids are accessible by water. Additionally, for the same permeability value, the total air voids were 6 to 9 percent higher than the interconnected air voids.

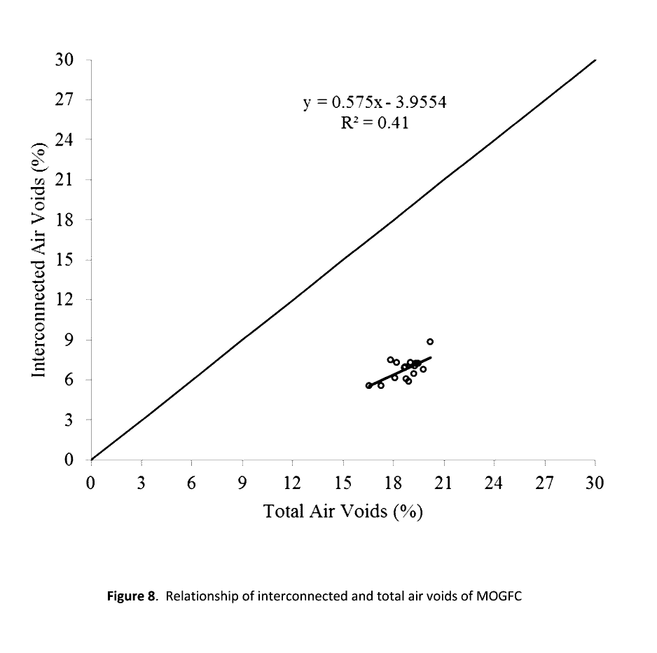

Various MOGFC embodiments were prepared by adding different adsorbent dosage into the voids of OGFC samples. The total air voids, interconnected air voids, and permeability were measured following the same procedure used for determining these in the OGFC samples. This was done to evaluate the air void contents and permeability changes in MOGFC after adding different amount of adsorbents into the MOGFC. The total air voids and interconnected air voids are plotted in FIG. 8. Interconnected air voids increase as total air voids increase, with a correlation coefficient of approximately 0.41. Also, the range of interconnected air voids was smaller than total air voids. As compared to interconnected and total air voids of OGFC plotted in FIG. 6, interconnected and total air voids in the MOGFC were reduced. The reduction of interconnected and total air voids in the MOGFC results from the addition of adsorbent particles and the subsequent decrease in the amount of air void space in the MOGFC. The correlation coefficient of MOGFC was slightly smaller than the correlation coefficient of OGFC. One possible explanation is that different dosages of adsorbent were introduced into MOGFC samples, and therefore uniform reduction of air voids could not be observed.

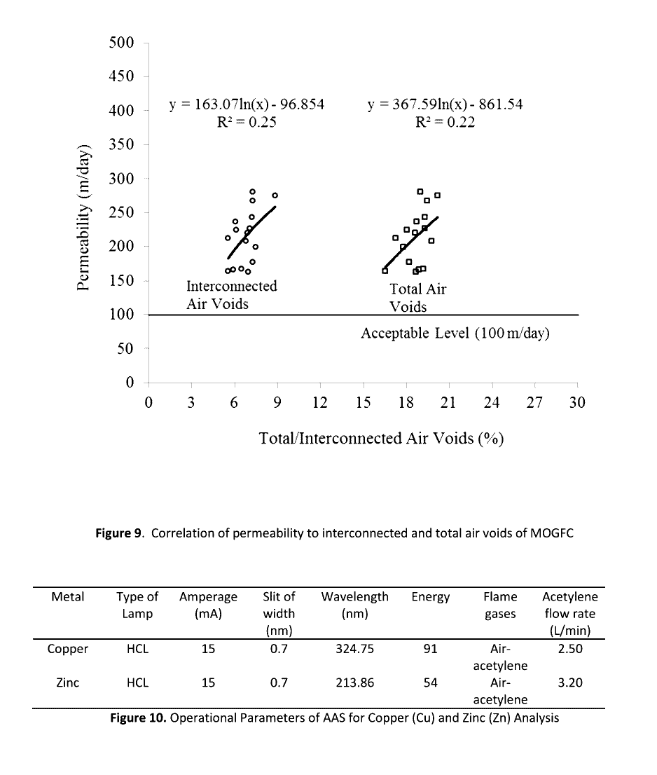

The permeability of MOGFC samples were measured and plotted as a function of total air voids and interconnected air voids in FIG. 9. Permeability increases as interconnected and total air voids increase. The corresponding correlation coefficients of permeability were approximately 0.25 and 0.22, respectively. These two values for MOGFC were much lower than those for OGFC. For the same permeability value of MOGFC, total air void differs by approximately 10 to 12 percent from interconnected air voids. This difference was higher than of OGFC.

The average rate of permeability of MOGFC was calculated as approximately 214 meters/day, which was smaller than the rate of permeability of OGFC (approximately 248 meters/day). The lower rate of permeability value was expected as the water flowing through the MOGFC is interrupted by the adsorbent particles, which are present in the voids of MOGFC. The lower rate of permeability in MOGFC is still above the minimum permissible value, 100 meter/day. This indicates that, despite having a reduced air void content as compared to OGFC, the MOGFC still has a sufficient water removal capacity to avoid accumulation of highway runoff on the road surface.

### Example 2

The adsorption of Cu and Zn on different adsorbents was carried out using the batch method explained in Example 1 at approximately room temperature (approximately 25° C.). A desired amount of adsorbent was placed in several 250 ml conical flasks. Approximately 100 ml of approximately 5 mg/L concentration Cu solution was prepared and mixed with the adsorbent to test the adsorption capacities. Similarly, a Zn solution of approximately 5 mg/L concentration was prepared and mixed with the adsorbent to test the adsorption capacities. One sample of the same concentration without adsorbent (blank) was also prepared and treated under the same condition. The solution without adsorbent was used as a reference to establish the initial concentration for the flasks containing adsorbent. All conical flasks were capped and placed on an Excella incubator shaker (Model E24, New Brunswick Scientific Co.) for approximately 24 hours. The flasks were then removed and solutions were filtered using a filter paper (Whatman Q5 dia 47 mm). The metal concentration (Cu and Zn) of the filtered aqueous phase was determined by a Perkin Elmer Atomic Absorption Spectrometer (AAS) (Model PinAAcle 900T). FIG. 10 lists the operational parameters of the AAS. The solid phase concentration was calculated by subtracting the final concentration from the initial concentration using Eq. (2).

$$q = \frac{( {C}_{∘} - {C}_{e} ) V}{m} \qquad ( 2 )$$

Where q=equilibrium solid-phase concentration (mass adsorbate/mass adsorbent), (milligrams/grams); m=mass of adsorbent, (grams); Ce=equilibrium concentration of the metal in the liquid phase, (mg/L); C₀=initial concentration of solute in the untreated solution, (mg/L); V=volume of solution, (L).

The Freundlich model (Eq. 3) and Langmuir model (Eq. 4) were used. A non-linear curve fitting technique was used to fit experimental data with these two models. The Freundlich isotherm can be used for a non-ideal sorption that involves heterogeneous sorption and expressed as:

qₑ=K_{F}Cₑ^{1/n} (3)

Where, qₑ (mg/g) is the amount of metal adsorbed, Cₑ (mg/L) is the concentration of metal in solution, K_{F} and 1/n are parameters of the Freundlich isotherm denoting a distribution coefficient (L/g) and intensity of adsorption, respectively.

The Langmuir isotherm has been successfully applied to many sorption processes. It describes the reversible chemical equilibrium between identical surface adsorption sites and liquid-phase adsorbate concentration, which allows a monolayer of adsorbate at saturation. The model can be represented as:

$${q}_{e} = {q}_{max} \frac{{K}_{L} Ce}{1 + {K}_{L} Ce} \qquad ( 4 )$$

Where, qₘₐₓ (mg/g) and K_{L} (L/g) are Langmuir constants representing maximum adsorption capacity and binding energy, respectively.

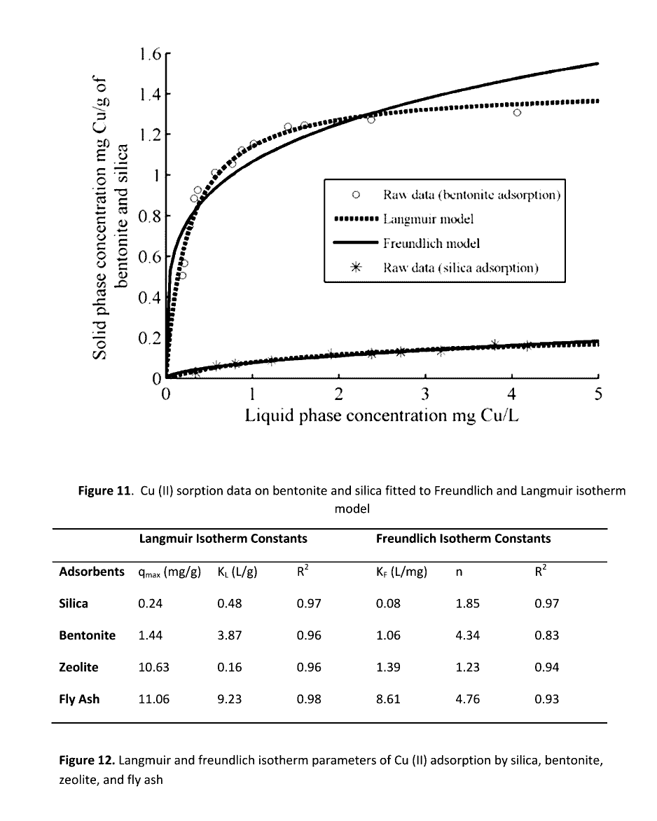

The data for the adsorption of Cu by bentonite was fitted to both Langmuir and Freundlich adsorption isotherm models, as shown in FIG. 11. The fitting parameters are listed in FIG. 12. The Langmuir (R²=approximately 0.96) isotherm exhibited a better fit compared to the Freundlich (R²=approximately 0.83) adsorption isotherm. The fact that the Langmuir isotherm fits the experimental data very well indicates that there was almost complete monolayer coverage of the adsorbent particles. For the Freundlich isotherm, an “n” value between 2 and 10 represents good adsorption. The “n” value of approximately 4.34, for Cu, in FIG. 12 is an indication of good adsorption of Cu by bentonite. The Langmuir isotherm constant K_{L}=approximately 3.87 L/mg represents the affinity of Cu to the binding sites on the bentonite and qₘₐₓ=approximately 1.44 mg/g represents the maximum adsorption capacity corresponding to complete the monolayer coverage.

The adsorption capacity of silica, for Cu, was calculated using Langmuir and Freundich adsorption isotherm models, as shown in FIG. 11. The model constants in FIG. 12 indicate that both Langmuir (R²=approximately 0.97) and Freundlich (R²=approximately 0.97) models can describe the adsorption data very well. The adsorption capacity constants (qₘₐₓ=approximately 0.24 mg/g and K_{F}=approximately 0.08 L/mg) from both the Langmuir and Freundlich models show much lower values than the bentonite adsorption capacity constants. This suggests that silica has a lower adsorption capacity for Cu, compared to that of bentonite.

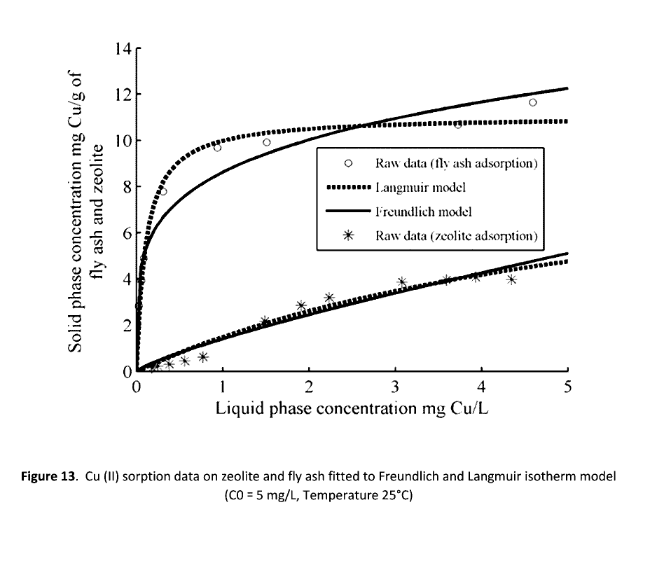

Zeolite adsorption capacity for Cu was determined using Langmuir and Freundich adsorption isotherm models, as shown in FIG. 13. The calculated Langmuir and Freundlich constants are shown in FIG. 12. Both models showed good fit to the experimental data, however Langmuir (R²=approximately 0.96) model followed a slightly better trend of the experimental data than the Freundlich (R²=approximately 0.94) model. The Langmuir constants qₘₐₓ=approximately 10.63 mg/g and K_{L}=approximately 0.16 L/mg were obtained. The higher value of qₘₐₓ indicates that zeolite has a higher adsorption capacity for Cu than that of bentonite (approximately 1.44 mg/g) and silica (approximately 0.24 mg/g). The Freundlich isotherm constant K_{F}=approximately 1.39 L/mg represents the Cu adsorption capacity of zeolite and n=approximately 1.23 represents the intensity of the adsorption on the bentonite surface.

The Langmuir and Freundlich parameters for adsorption of Cu by fly ash are listed in FIG. 12. The comparison of experimental data and predicted values for both the models are also shown in FIG. 13. The data in FIG. 13 indicates that adsorption of Cu by fly ash can best be described by Langmuir model (R²=approximately 0.98). Furthermore, fly ash shows the highest qₘₐₓ and “n” value of all four adsorbents that were tested for Cu adsorption. The “n” value for fly ash of approximately 4.76 for Cu, shows that adsorption of Cu by fly ash was more favored than adsorption of Cu by bentonite (n=approximately 4.34), silica (n=approximately 1.85), and zeolite (n=approximately 1.23). Similarly fly ash demonstrated a higher adsorption capacity (qₘₐₓ=approximately 11.06 mg/g) for Cu than that of zeolite (approximately 10.63 mg/g), bentonite (approximately 1.44 mg/g), and silica (approximately 0.24 mg/g).

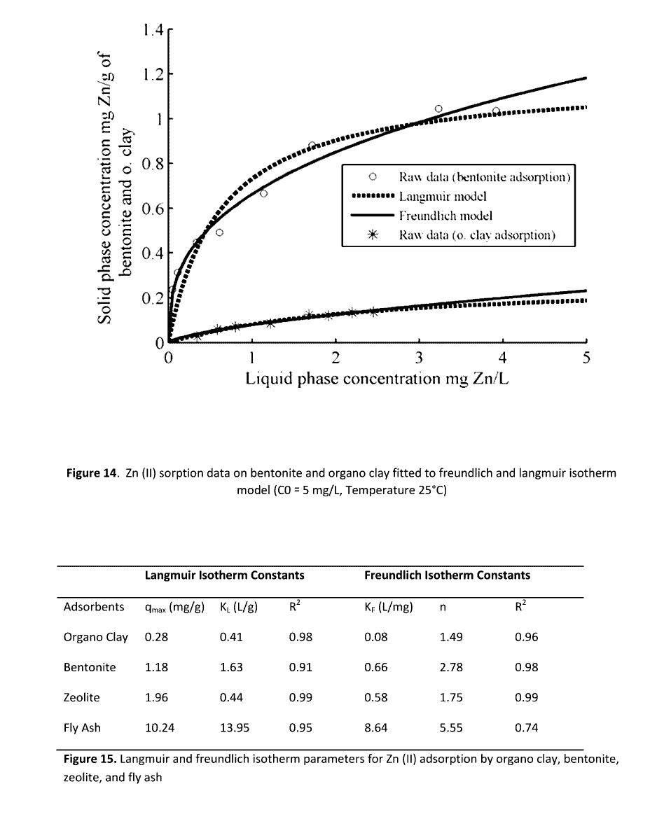

The experimental data of Zn adsorption onto bentonite was regressively analyzed with the Langmuir and Freundlich isotherm models, as shown in FIG. 14. The relative constant values with regression coefficients calculated from the two models are listed in FIG. 15. It can be concluded from the constants that the Freundlich (R²=approximately 0.98) model simulates the experimental data better than the Langmuir (R²=approximately 0.91) model. Zn adsorption onto bentonite gives an “n” value of approximately 2.78, as shown in FIG. 15. The “n” value of approximately 2.78 indicates that adsorption is favored. The other Freundlich constant, K_{F}, indicates the adsorption capacity of the adsorbent. The Langmuir isotherm constant qₘₐₓ=approximately 1.18 mg/g represents the maximum adsorption capacity and K_{L}=approximately 1.63 L/mg represents the affinity of Zn to the binding sites on the bentonite.

The experimental data of Zn adsorption onto organo clay was analyzed with the Langmuir and Freundlich isotherm models and the results are shown in FIG. 14. The R² values listed in FIG. 15 showed that the Langmuir (R²=approximately 0.98) model has a better fit with the experimental data than the Freundlich (R²=approximately 0.96) model. However, the adsorption capacity constants (qₘₐₓ=approximately 0.28 mg/g and K_{F}=approximately 0.08 L/mg) from both the Langmuir and Freundlich models show that organo clay has a lower adsorption capacity for Zn than that of bentonite (approximately 1.18 mg/g).

The Langmuir and Freundlich parameters for the adsorption of Zn onto zeolite are listed in FIG. 15. Both the Langmuir (R²=approximately 0.99) and Freundlich (R²=approximately 0.99) models can adequately describe the adsorption data. The parameter, qₘₐₓ=approximately 1.96 mg/g, which is related to the adsorption capacity, indicates that the Zn adsorption capacity of zeolite is higher than that of both bentonite (approximately 1.18 mg/g) and organo clay (approximately 0.28 mg/g). However, in terms of favorability of adsorption, zeolite (n=approximately 0.58) is less favorable than that of bentonite (n=approximately 0.66) for Zn adsorption.

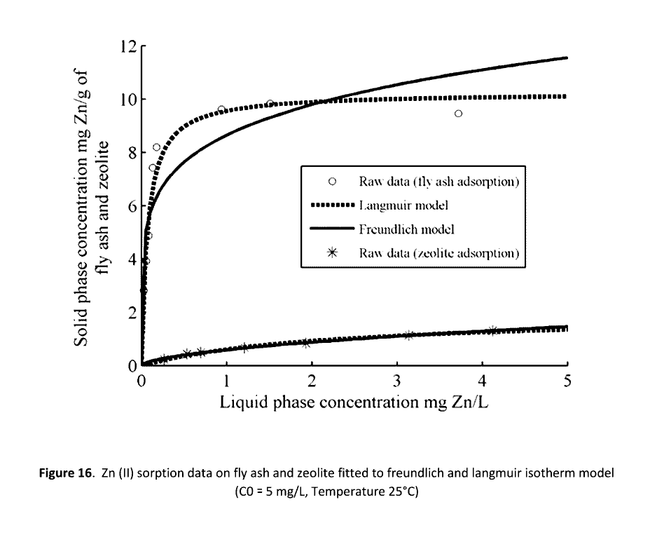

The adsorption of Zn by fly ash was fitted to both the Langmuir and Freundlich adsorption isotherm models, as shown in FIG. 16. The fitting parameters are listed in FIG. 15. The Langmuir model (R²=approximately 0.95) gives a better fit compared to the Freundlich (R²=approximately 0.74) model. The Langmuir isotherm constants, qₘₐₓ=approximately 10.24 mg/g and K_{L}=approximately 13.95 L/mg, indicate a higher affinity of Zn to the binding sites of fly ash than that of Zn to other adsorbents. According to Table 15 fly ash has an “n” value of approximately 5.55, which is an indication of good adsorption of Zn by fly ash.

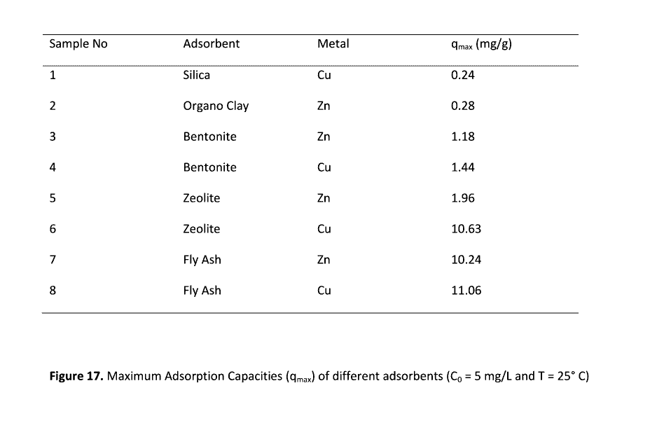

Cu and Zn adsorption capacities for each of the adsorbents are compared in a table in FIG. 17. It is clear from the Table that silica and organo clay both have very low adsorption capacities for Cu and Zn, respectively. Bentonite, zeolite, and fly ash provided moderate to high adsorption capacities for both Cu and Zn.

### Example 3

A metal removal test was conducted using the Florida Department of Transportation's Falling Head Laboratory Permeability Test equipment, as shown in FIG. 5. Each MOGFC embodiment was placed inside the metal cylinder following the same procedures described in Example 1. The permeameter valve was adjusted to allow approximately 1000-mL of metal solution to pass through the MOGFC sample at a relatively constant rate while being timed. The whole filtration took approximately 1.5 hours. The metal concentration of the filtrate was analyzed by the AAS. Finally, the percentage of metal removal was calculated by subtracting the final concentration from the initial concentration using Eq. 5.

$$\% Metal Removal Efficiency = \frac{( {C}_{∘} - {C}_{f} )}{{C}_{∘}} \times 100 \qquad ( 5 )$$

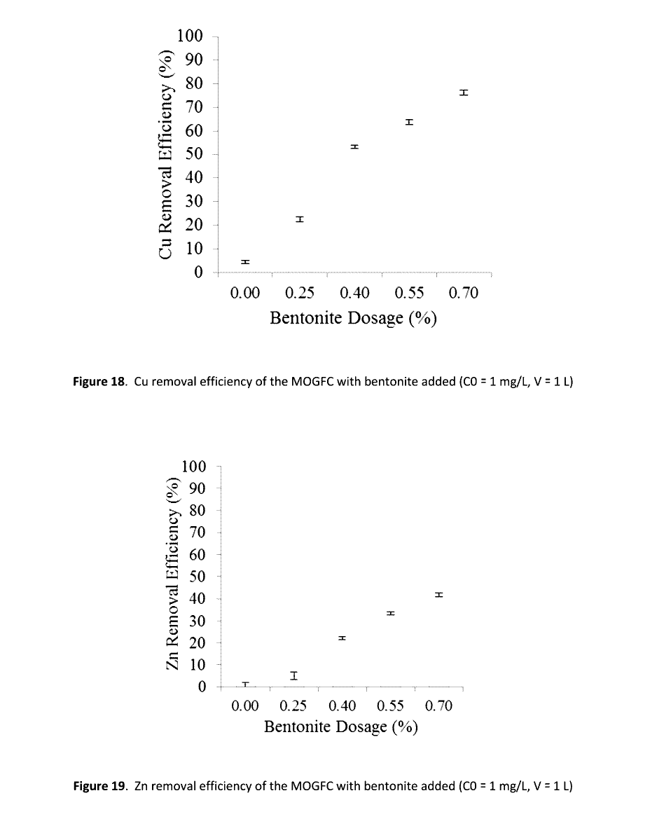

The Cu and Zn removal efficiencies of MOGFC with different bentonite dosages is plotted in FIGS. 18 and 19, respectively. The maximum amount of bentonite included in a MOGFC sample was approximately 0.70% of the total mass. Conventional OGFC, without any bentonite dosage, did not show any significant removal of either Cu or Zn. However after introducing bentonite, Cu and Zn removal efficiencies were significantly improved. The maximum removal efficiency of bentonite for Cu is approximately 76.3%, which is greater than the removal efficiency for Zn at approximately 41.8%. This suggested that a MOGFC embodiment with bentonite could adsorb more Cu than Zn. These findings agreed well with the Example 2 results.

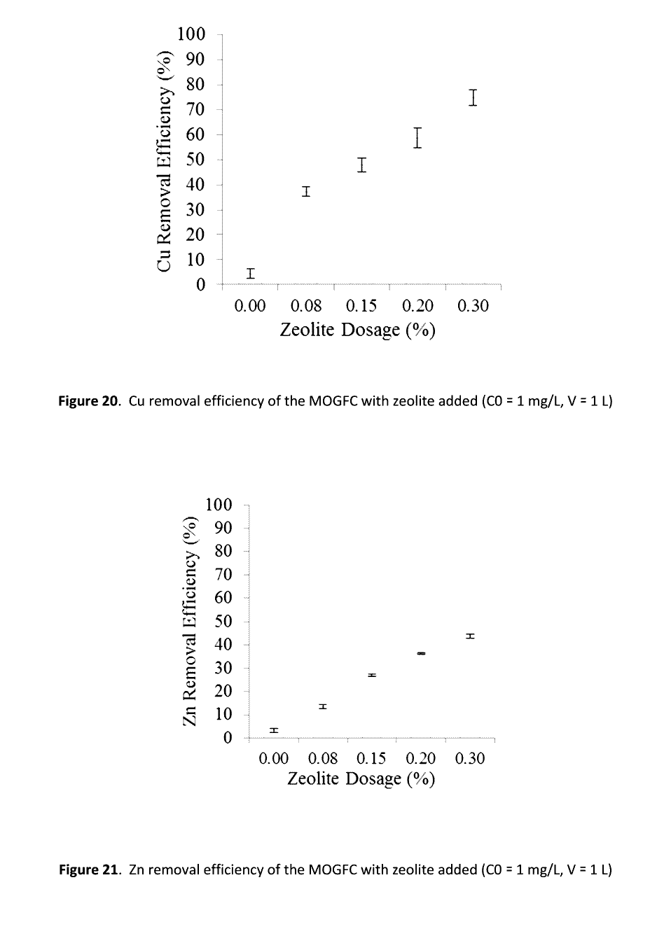

MOGFC embodiments were made using the procedure described above. MOGFC with different zeolite dosages was tested for Cu and Zn removal efficiency and the data is plotted in FIGS. 20 and 21, respectively. MOGFC permitted a maximum of approximately 0.30% zeolite inclusion into its voids, so that zeolite constituted about 0.30% of the total mass. This value was lower than that of bentonite because the larger particle size of zeolite prevented addition into the voids. The maximum removal efficiency of zeolite for Cu was approximately 73.7%, which is greater than the maximum removal efficiency of zeolite for Zn, which was approximately 43.7%. Thus a MOGFC embodiment with zeolite could adsorb more Cu than Zn. These findings agreed well with the results in Example 2.

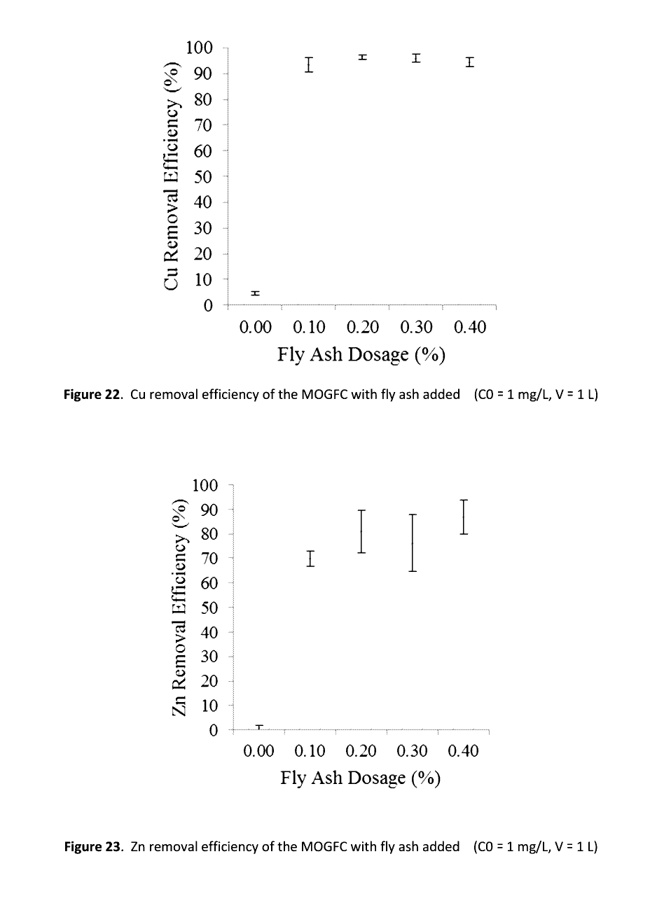

Cu and Zn removal efficiencies of MOGFC with different fly ash dosages were plotted in FIGS. 22 and 23, respectively. MOGFC permitted a maximum of approximately 0.40% fly ash inclusion into its voids so that fly ash constituted approximately 0.40% of the total mass. As expected, conventional OGFC, without any fly ash dosage, did not show any significant removal either for Cu or Zn. After introducing fly ash, Cu and Zn removal efficiencies were significantly improved. The maximum removal efficiency of fly ash for Cu is approximately 94.6%, which is greater than the removal efficiency for Zn, which was approximately 86.7%. This means a MOGFC embodiment with fly ash could also adsorb more Cu than Zn and this again agreed with the results in Example 2.

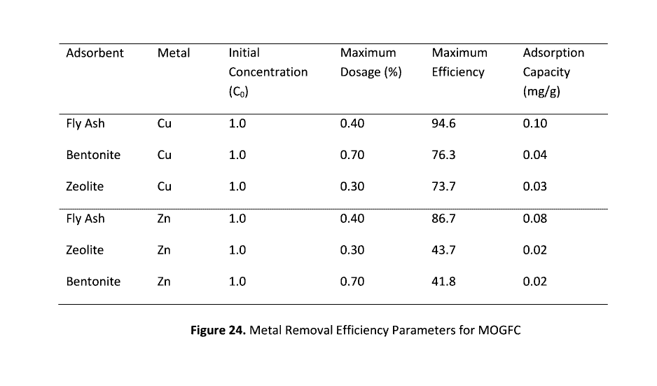

Next three MOGFC samples were prepared using the method discussed above. One adsorbent was added to each sample. Maximum removal efficiencies are listed in FIG. 24. Fly ash, bentonite, and Zeolite showed a removal efficiency of approximately 94.6%, 76.3%, and 73.7%, for Cu, respectively. Fly ash, bentonite, and zeolite showed a removal efficiency of approximately 86.7%, 41.8%, and 43.7%, for Zn, respectively. Each adsorbent has a higher removal efficiency with Cu in comparison with the removal efficiency for Zn, which agreed well with the results in Example 2. Among all of the embodiments, fly ash had the best removal efficiency for both Cu and Zn. According to Example 2, more Cu was adsorbed by zeolite, but during the MOGFC metal removal in Example 3 bentonite had a high removal efficiency for Cu. This might be caused by the lower dosage of zeolite in MOGFC and the greater contact time during Example 2.

### Example 4

The moisture susceptibility of the OGFC and MOGFC embodiments was determined in accordance to T283 method (AASHTO 2007) and using the 810 Material Testing Machine of MTS Systems Corporation. Two sets of OGFC embodiments (each set containing 3 samples) were prepared. Both sets were aged and stored for approximately 72 hours at room temperature. After aging, one set of samples was conditioned in water by placing it in a hot water bath at approximately 60° C. for approximately 24 hours. This set of samples is referred to herein as the conditioned set and the other set is referred to as the control set. Both conditioned and controlled sets were then placed in a controlled temperature bath at approximately 25° C. for approximately 3 hours. Then both sets of samples were tested for indirect tensile strength (ITS) by loading each specimen at a constant rate of approximately 50 millimeters/minute and measuring the load required to break the specimen using Eq. 6.

$$Indirect Tensile Strength ( I T S ) = \frac{2 P}{π Dt} \qquad ( 6 )$$

Where, P=load at failure (pounds), D=diameter of the sample (inches), t=thickness of the sample (inches).

The indirect tensile strength of the conditioned sample was then compared to the controlled sample to determine the tensile strength ratio (TSR) using Eq. 7.

$$T S R = \frac{average I T S of conditioned samples}{average I T S of controlled samples} \qquad ( 7 )$$

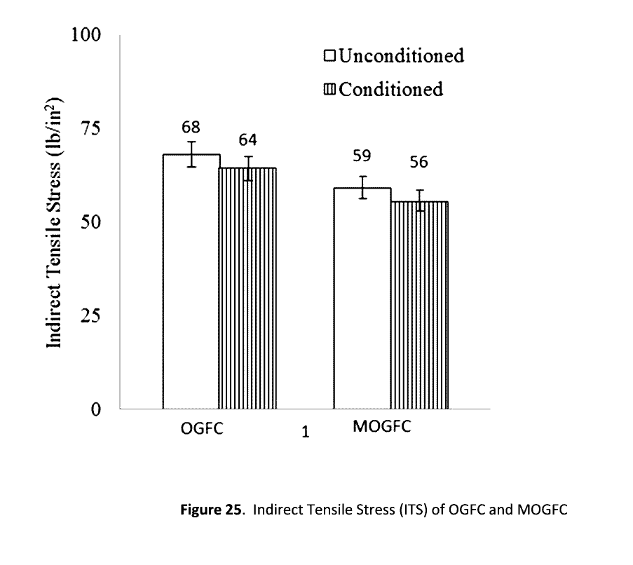

Indirect tensile stresses (ITS) of conditioned and unconditioned samples are shown in FIG. 25 for OGFC and one embodiment of MOGFC. The TSR was approximately 94.4% for OGFC and approximately 94.2% for MOGFC. No significant change in TSR values were observed in MOGFC and OGFC during the moisture conditioning. The TSR values for both MOGFC and OGFC were above the AASHTO standard of 80%. Thus MOGFC is resistant to moisture induced damage.

Examples 1 on air void and permeability demonstrated that MOGFC has a sufficient water removal capacity to avoid accumulation of highway runoff on the road surface. Example 2 on the various adsorbents demonstrated that bentonite, zeolite, and fly ash each possess significant metal adsorption capacity for the metals Cu and Zn. Example 3 on MOGFC metal removal efficiency demonstrated that with an increase in the adsorbent dosage, the metal removal efficiency also increases. Example 3 also indicated that MOGFC comprising bentonite, zeolite, or fly ash had higher metal removal efficiencies and higher adsorption capacities for Cu, in comparison with the metal removal efficiencies and adsorption capacities for Zn. Additionally, Example 4 demonstrated that both the OGFC and MOGFC mixtures used in this example were highly resistant to moisture induced damage.

For the purpose of understanding the MOGFC and method of treating highway or roadway runoff using the MOGFC, references are made in the text to exemplary embodiments of the MOGFC and the methods of treating highway runoff using the MOGFC, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the MOGFC and method of treating highway runoff using the MOGFC may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change to the basic function to which it is related.

For the purpose of understanding the multi-functional open graded friction course, references are made in the text to exemplary embodiments of an multi-functional open graded friction course, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the multi-functional open graded friction course may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change to the basic function to which it is related.

1. A multi-functional open graded friction course comprising:
(a) an open graded friction course comprising void spaces; and
(b) an additive, said additive being applied to the surface of said open graded friction course and then allowed to move into the void spaces of the open graded friction course.

2. The multi-functional open graded friction course of claim 1, wherein said additive comprises an adsorbent.

3. The multi-functional open graded friction course of claim 2, wherein said adsorbent is selected from the group consisting of bentonite, zeolite, fly ash, organo clay, and silica.

4. The multi-functional open graded friction course of claim 2, wherein said adsorbent comprises fly ash.

5. The multi-functional open graded friction course of claim 2, wherein said adsorbent comprises bentonite.

6. The multi-functional open graded friction course of claim 2, wherein said adsorbent comprises zeolite.

7. The multi-functional open graded friction course of claim 2, wherein said adsorbent comprises organo clay.

8. The multi-functional open graded friction course of claim 2, wherein said adsorbent comprises silica.

9. A multi-functional open graded friction course comprising:
(a) an open graded friction course comprising void spaces; and
(b) at least one additive, said additive being applied to the surface of the open graded friction course.

10. The multi-functional open graded friction course of claim 9, wherein said at least one additive comprises an adsorbent.

11. The multi-functional open graded friction course of claim 10, wherein said adsorbent is selected from the group consisting of bentonite, zeolite, fly ash, organo clay, or silica.

12. The multi-functional open graded friction course of claim 10 wherein said adsorbent is fly ash.

13. A method of treating highway water runoff, in situ, comprising:
(a) adding open graded friction course, comprising void spaces, over a roadway surface;
(b) treating the surface of the open graded friction course with an additive, after treatment said additive being located in said void spaces of said open graded friction course;
(c) treating water, comprising at least one pollutant, located on said open graded friction course to remove said at least one pollutant.

14. The method of claim 10, wherein said additive is an adsorbent.

15. The method of claim 11, wherein said adsorbent is selected from the group consisting of bentonite, zeolite, fly ash, organo clay, or silica.

16. The method of claim 10, wherein said adsorbent is fly ash.

17. The method of claim 10, wherein said adsorbent is bentonite.

18. The method of claim 10, wherein said adsorbent is zeolite.

19. The method of claim 10, wherein said adsorbent is organo clay.

20. The method of claim 10, wherein said adsorbent is silica.
